(19) United States
(12) Patent Application Publication
(10) Pub. No.: US 2009/0031827 A1
(43) Pub. Date: Feb. 5, 2009

(54) Smart sample Extraction Device and Method

(75) Inventor: Sadeq Ahmad AL-Qassem, Kuwait (KW)

Correspondence Address: FURR LAW FIRM, 2622 DEBOLT ROAD, UTICA, OH, 43080, US

(73) Assignee: UNIVERSITY OF KUWAIT, Safat (KW)

(21) Appl. No.: 11/834,007

(22) Filed: Aug. 5, 2007

(51) Int. Cl. G01N 1/10

(52) U.S. Cl. 73/863.02; 422/100; 422/102; 422/106; 422/109; 73/863.01; 73/863.11

(57) ABSTRACT

The current invention is a device that is operated by an operation button. The user chooses the required sample and determines its quantity and then presses the button to extract the sample during several seconds in a special pot while another sample is extracted at the same time and put in the same pot to mix the samples then to heat, cool or mixed them together or shaking the sample (vibrate movement) in different speed.

### FIELD OF THE INVENTION

The field of the present invention relates generally a device and method for the extracting the chemical samples in the suitable quantity.

### BACKGROUND OF THE INVENTION

The idea of extracting the chemical samples in the suitable quantity or the required volume represents a heavy burden on a user. They can make mistakes while making reading or spill the sample outside the holding cup.

### PRIOR ART REFERENCE AND DISCUSSION

U.S. Pat. No. 7,165,444 by Zhang, et al. and issued on Jan. 23, 2007, is for a Concentrating column and sample processing device useful for elemental analysis of trace metals. It discloses a concentrating column useful for elemental analysis of trace metals consists mainly of column body, filtration membranes 6 fixed at the fluid inlet end and the outlet end of the column body, and column packing 8 packed inside the column body, wherein column packing 8 is prepared from the swollen and cleaned macroporous adsorbent resin of high, medium or non-polarity treated with a mixture of 3 mol/L NH.sub.4OH-1 mol/L HAC-3.0.about.6.0.times.10.sup.-4 mol/L pyridin-(2-azo-4-)resorcin or a mixture of 0.5 mol/L Na.sub.2HPO.sub.4-1.0.about.2.0.times.10.sup.-4 mol/L pyridin-(2-azo-4-)resorcin by dynamic on-column treatment or static immersion treatment.

U.S. Pat. No. 7,138,628 by Tomimatsu, et al. and issued on Nov. 21, 2006, is for a Method and apparatus for specimen fabrication. It discloses a specimen fabrication apparatus including: a specimen chamber, a sample stage in the specimen chamber, to mount a specimen substrate, a transfer unit to extract a micro-specimen from the specimen substrate, and to transfer the micro-specimen, within the specimen chamber; a specimen holder in the specimen chamber, to receive the micro-specimen from the transfer unit, and to have the micro-specimen affixed thereto, and an irradiating optical system to irradiate an ion beam to the specimen substrate or to the micro-specimen affixed to the specimen holder, wherein the transfer unit effects transfer of the micro-specimen from the specimen substrate to the specimen holder, and the irradiating optical system irradiates the ion beam onto the micro-specimen affixed to the specimen holder, while the specimen chamber remains substantially sealed.

U.S. Pat. No. 7,105,132 by Shumate, et al. and issued on Sep. 12, 2006, is for a Liquid chemical distribution method and apparatus. It discloses a chemical solution distribution system and method that includes or employs a plurality of liquid handlers where each of the liquid handlers includes a movable table that engages a sample multiwell plate and can align pipettes of the station with different subsets of wells of the multiwell plate where the number of wells of the multiwell plate is a multiple of the number of pipettes of the head of the pipette station. The system further includes and employs four different pumps to enable the system and method to supply four different solutions to wash stations of each of the four liquid handlers.

U.S. Pat. No. 7,100,689 by Williams, et al. and issued on Sep. 5, 2006, is for a Sensor apparatus and method of using same. It discloses a system and method for sensing the characteristics of a fluid in a sub-surface formation. In one embodiment, the invention relates to a sensor apparatus for sensing a chemical in a vapor emitted by a sub-surface fluid sample. In various configurations, the apparatus senses the presence and/or percentage of water, the presence of a gas, an oil/gas ratio, an aliphatic/aromatic hydrocarbon ratio, and/or the presence of corrosive or poisonous chemicals.

U.S. Pat. No. 7,073,403 by Albro, et al. and issued on Jul. 11, 2006, is for a Method and apparatus for the collection of samples. It discloses a system for the collection of near real time confirmation samples is provided to quickly eliminate false positive alarms by confirming the presence or absence of a chemical agent when a monitor operating in near real time to detect the presence of that chemical agent generates an alarm. The confirmation sampling system is synchronized with the near real time monitor and the confirmation sampler and monitor draw common samples of the atmosphere of concern. In the event that the monitor generates an alarm, the confirmation sampler preserves the sample taken contemporaneously with the alarm event for separate analysis, and also takes and preserves one or more follow-on samples.

U.S. Pat. No. 5,013,443 by Higashidate, et al. and issued on May 7, 1991, is for an Extraction and separation method and apparatus using supercritical fluid. It discloses an extraction and separation method and apparatus using a supercritical fluid for extracting a specified component from a sample by a supercritical fluid and introducing the supercritical fluid containing the extracted component into a silica gel column coated with silver nitrate so as to separate the extracted component. By the combination of the extracting operation by a supercritical fluid under mild conditions and chromatography taking the advantage of the selectivity of the silica gel column coated with silver nitrate to olefins, the extract is obtained at a high concentration without producing denaturation. It is assigned to Nihon Bunko Kogyo Kabushiki Kaisha.

There are no other devices that include 3 samples or more at the same time and extracted with the required quantities under changeable temperatures and mixing. There is still improvement in the art.

### SUMMARY OF THE INVENTION

The current invention is a device to extract the chemical samples automatically. It's an isolated unit that helps the user to extract the required quantity of the sample without the human mistakes that occurs in the laboratory very quickly with the possibility of mixing the sample with other items then heating or cooling or vibration movement.

### REQUIRED PARTS

1, 4 Primary tank
2, heater
3, accumulating tank
4, Electronic stirrer
5, Water level controller
6, 4 Water pump
7, Temperature control
8, Stirrer control
9, Compressor cooling system
10, Selector switch
11, ON/OFF switch

### BRIEF DESCRIPTION OF THE DRAWINGS

The above and other aspects, features, and advantages of the present invention will be better and more fully understood by those skilled in the art with reference to the following detailed and more particular description of specific and preferred embodiments thereof, presented in conjunction with the following drawings to show how the same may be carried into effect, wherein:

FIG. 1 shows the steps of the device;

FIG. 2 shows a block diagram of the device;

FIG. 3 shows the device;

FIG. 4 shows the tanks and hosing;

FIG. 5 displays the pump circuit schematics;

FIG. 6 displays a four pump circuit schematics;

FIG. 7 displays the selector switch circuit schematics; and

FIG. 8 displays a view of the control section.

### DETAILED DESCRIPTION OF THE INVENTION

There are a number of significant design features and improvements incorporated within the invention.

The current invention is a device to extract the chemical samples automatically. It's an isolated unit that helps the user to extract the required quantity of the sample without the human mistakes that occurs in the laboratory very quickly with the possibility of mixing the sample with other items then heating or cooling or vibration movement.

The device 1 is operated by the operation button 20. Then the user chooses the required sample 30 and determines its quantity and then he presses the operation button 20 to extract the sample during several seconds in an accumulation tank 100 while another sample is extracted at the same time and put in the same accumulation tank 100 to mix the samples then to heat, cool or mixed them together or shaking the sample (vibrate movement) at different speed.

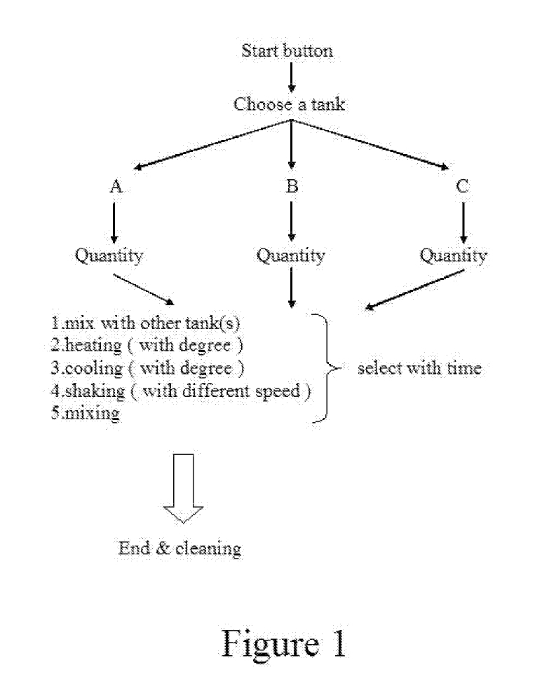

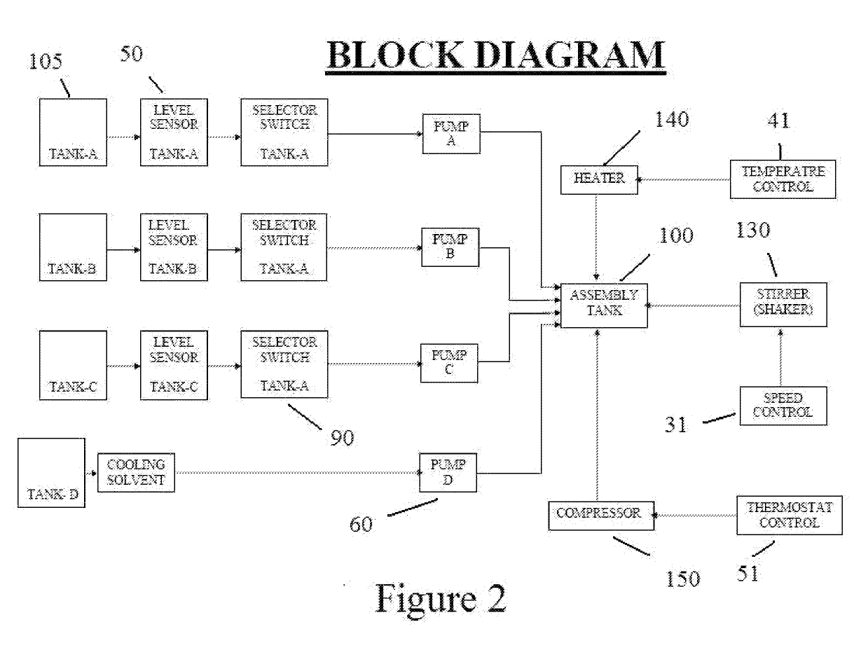

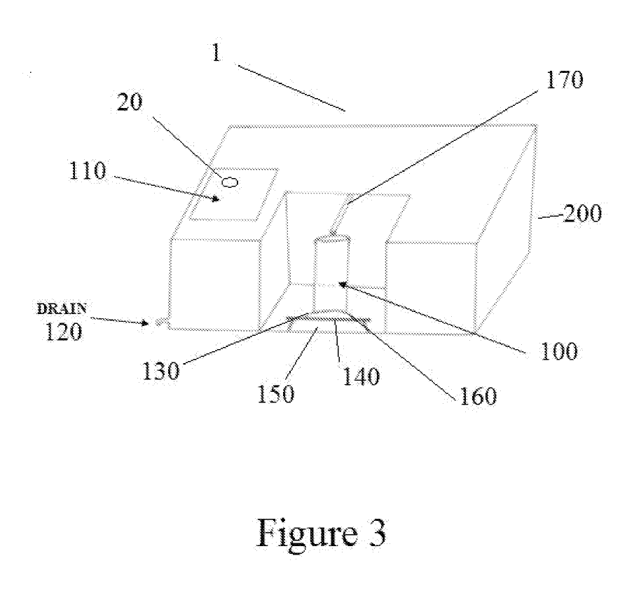

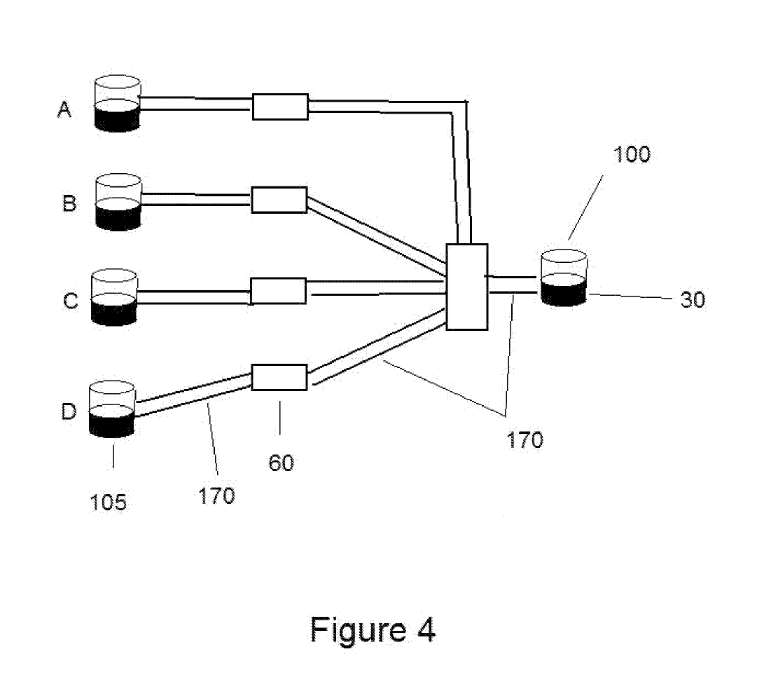

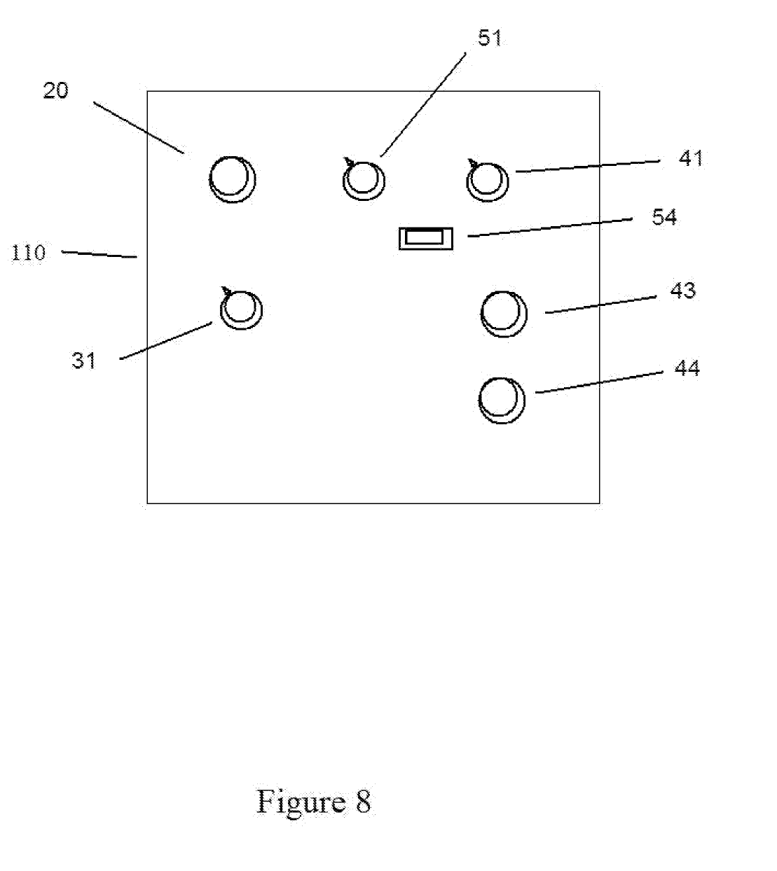

The device 1 is run by the device by the operation button 20 with the steps as shown in FIG. 1. When operating the device 1 the user choosing a tank 105 such as tank A, tank B or tank C and determining the required quantity to produce the sample 30. The tank 105 have components that can be used to produce the sample 30. Selecting component “A” in a certain quantity to be added to the assembly tank 100. Mixing with another component: For example from tank 105 “B” or tank “C” and determining their quantities as well. If required, the device 1 would heat the sample 30 to a certain temperature or cooling the sample 30 to a certain temperature. The device 1 would mix the sample 30. The device 1 will shake the sample if required by the stirring means 160. After that the sample 30 has been prepared the completion button 43 is pressed so the device 1 will work automatically in cleaning its internal parts with the pot after using it. The device will have a special cleaning button 44 for cleaning to use it any time. The device 1 may include more than one tank 105 for the experiment or the samples are to come from. The main components of the device 1 are four primary tanks 105, tank A, tank B, tank C and tank D, a heating means 140, a accumulating tank 100, a liquid level sensor and controller 50, a plurality of water pumps 60, a temperature control for a heater 41, a stirrer control 31, a stirrer 130, a cooling means such as a Compressor cooling system 150, a temperature control for a heater 51, and a selector switch 90. A Block Diagram of the device 1 is shown in FIG. 2. FIG. 3 displays the casing 200 of the device 1 with the control section 110 as shown in more detail in FIG. 8 which has all of the switches and controllers on it. The casing 200 will have a drain 120 to drain out any liquids out of the casing 200. The assembly tank 100 sits in front of the casing 200 with the casing 200 extending out on the sides of the assembly tank 100. The assembly tank 100 sits on the assembly tank holder 130 which contains the heating means 140 and cooling means 150 as well as the stirrer 160. There is a tube system 170 which runs from tanks 105, tank A, tank B, tank C and tank D through the pumps 60 for each tank to the assembly tank 100 as shown in FIG. 4.

The device 1 has a main on/off switch 20. There is a liquid level control switch and sensor 50 which controls the pumps 60 as shown in FIG. 3. There are selector switches 90 for each of the sample tanks of which one in the preferred embodiment is cleaning water. In the preferred embodiment there are three sample tanks 105, tank A, tank B, tank C with a tank D for the cleaning water.

There is a temperature control 51 for the heater 140 has an ON/OFF switch for the heating means 140. This control switch makes it on/off for temperature. It is a digital temperature control that will set the temperature of the sample. It will have an indicator lamp 54 letting the user know when it has hit the right temperature. It will maintain that temperature automatically.

There is a temperature control for the cooling means has an ON/OFF switch for the cooling system. This control switch makes it on/off for temperature. It is a digital temperature control that will set the temperature of the sample. It will use the indicator lamp 54 letting the user know when it has hit the right temperature. It will maintain that temperature automatically.

This stirrer control switch 31 the controls the on/off and the speed for stirrer control 160

A user would fill the 3 primary tanks 105, tank A, tank B, tank C. with required sample 30 and the 4^{th} tank with water or a cooling solvent. Tank hoses 170 are connected from the tanks 105 to the accumulating tank 100 which is controlled by three tank controlling units. The accumulating tank 100 is facilitated with a stirrer 130, a heating means 140 and a cooling means 150 like a compress Cooler which works as per the preset controlling units on the control panel 110.

When the device 1 is started the samples from the three primary tanks 105 flow to the accumulating tank 100 and as preset desired temp: (hot or cold) and the preset stirring time the units completes the works schedules on it.

The accumulating tank 100 can be taken out of the Device 1 and the produced the sample can be stored in the accumulating tank 100 or another vessel.

When the process is finish the user will press the clean button 44 then the water from the 4^{th} tank D will flow thought the path in which the samples passed by cleaning the unit. The user would dispose the water from the accumulating tank 100. Then the machine is ready for another set of process.

For example, if a user wanted to apply the experiment of measuring the salt in the crude oil they may need three samples of “crude oil—Mixed Alcohol—Exalline”. To do this, the Oil will be put in the samples—related tanks 40 of the device 1. Then the buttons 50 of the sample tanks 40 containing the oil will be pressed to extract 10 cubic centimeters to the cup 60. Then the user will select to add 40 cubic centimeters of Mixed Alcohol which will be added to the cup 60. The user would then hit the mixing button 70 which will start the mixer means 75 to produce a measurable chemical solution. If this process if done without using the device 1 the user will have to spend a longer time and the user may have a mistake in the quantities. The user can also use the heater means 85 or cooling means 95 to reach a required temperature for the sample 30.

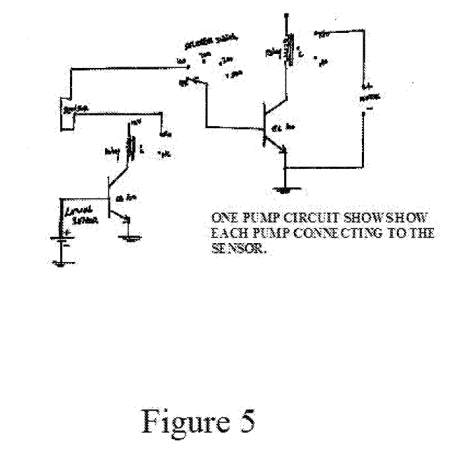

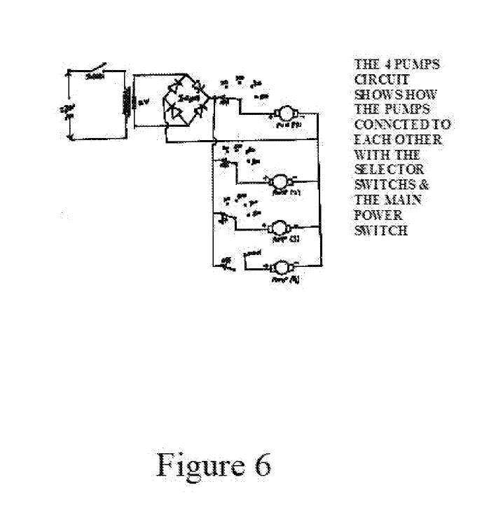

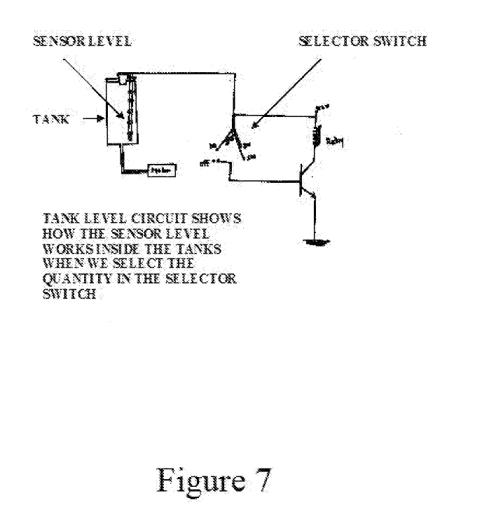

FIG. 5 displays a sample of the pump circuit schematics. FIG. 6 displays a sample of the four pump circuit schematics while FIG. 7 displays the selector switch circuit schematics.

### ADVANTAGES

The device offer many advantages over prior it. It allows for Quick productivity, avoiding personal mistakes, saving the user's efforts, avoiding the chemical leakages inside the laboratory, and Keeping each chemical in one place and isolated from the other to facilitate the process of taking them out.

### DISCLAIMERS

Although the present invention has been described with reference to the preferred embodiment thereof, it is apparent to those skilled in the art that a variety of modifications and changes may be made without departing from the scope of the present invention which is intended to be defined by the appended claims.

The skilled in the art will easily recognize that the automatic electronic window shading system of the present invention maybe integrated with or incorporated into other automatic/manual devices and new installation techniques that provide electronic tinting using technology available to the skilled in the art without further experimentation and are all claimed under the scope of this invention.

The methods of the present invention have been explained with reference to plurality of references the teachings of which are all incorporated herein by reference.

### EQUIVALENTS

From the foregoing description, one skilled in the art can easily ascertain the essential characteristics of this invention and, without departing from the spirit and scope thereof, can make various changes and modifications of the invention to adapt it to various usages and conditions. Such variations and changes may include, for example, altering the number of components or using equivalents. It is believed that such can be accomplished without excessive experimentation. In any case, any such variations are all claimed under the scope of this invention.

This invention has been described hereinabove, although with reference to a plurality of illustrative and preferred embodiments, it is to be understood that is in no way to be construed as limiting but only to provide examples. However, it is readily appreciated that, from reading this disclosure, the invention may be embodied in other specific forms without departing from the spirit or essential characteristics or attributes to bring modifications by replacing some elements of this invention as practiced by their equivalents, which would achieve the same goal thereof and accordingly reference should be made to the appended claims, rather than to the foregoing specification, as indicating the scope of the invention. Accordingly, those skilled in the art will recognize or be able to ascertain, using no more than routine experimentation, many equivalents to the specific embodiments and the scope of the invention being indicated by the appended claims described herein. Such equivalents, obvious variations, and all changes which come within the meaning and equivalency of the claims are therefore intended to be encompassed therein and are deemed covered by the claims of this invention.

What I claim as my invention is:

1. A device to produce a sample comprising: a plurality of tanks container components connected to an assembly tank where said assembly tank has a cooling, heating and stirring means.

2. A device according to claim 1 further comprising said assembly tank having a shaking means.

3. A device according to claim 1 further comprising said tanks are connected to a pump.

4. A device according to claim 1 further comprising having a control section.

5. A device according to claim 1 further comprising having a selector switch that will select a tank transferring material from the tank to the assembly tank.

6. A device according to claim 1 further comprising having a selector switch that will select a tank transferring material from the tank to the assembly tank.

7. A device according to claim 1 further comprising having an indicator lamp that lights when the sample hits the right temperature.

8. A device according to claim 1 further comprising having said heating means having a temperature control.

9. A device according to claim 1 further comprising having said cooling means having a temperature control.

10. A device according to claim 1 further comprising having said stirring means having a stirring control switch.

11. A device according to claim 1 further comprising having said a cleaning button.

12. A device according to claim 11 further comprising where said cleaning is engaged it will begin a cleaning cycle.

13. A device according to claim 1 further comprising having each tank having a level sensor.

14. A device according to claim 6 further comprising having a plurality of selector switches.

15. A device to produce a sample comprising: a plurality of tanks container components connected to an assembly tank where said assembly tank has a cooling, heating, shaking and stirring means where said tanks are connected to a pump with send device having a control section with said control section having a selector switch that will select a tank transferring material from the tank to the assembly tank, an indicator lamp that lights when the sample hits the right temperature, a temperature control, a stirring control switch and a cleaning button.

16. A device according to claim 15 further comprising where said cleaning is engaged it will begin a cleaning cycle.

17. A device according to claim 15 further comprising having each tank having a level sensor.

18. A device according to claim 15 further comprising having a plurality of selector switches.

19. A device according to claim 15 further comprising having an outer casing.

20. A device according to claim 15 further comprising having said outer casing having a drain.
